(19) United States
(12) Patent Application Publication
(10) Pub. No.: US 2021/0365220 A1
(43) Pub. Date: Nov. 25, 2021

(54) IMAGE PROCESSING SYSTEM, IMAGE PROCESSING APPARATUS, PROGRAM, CONTROL MANAGEMENT SYSTEM, AND DEVICE

(71) Applicant: Konica Minolta, Inc., Tokyo (JP)

(72) Inventor: Hirokazu HIGASHIUCHI, Tokyo (JP)

(73) Assignee: Konica Minolta, Inc., Tokyo (JP)

(21) Appl. No.: 17/317,954

(22) Filed: May 12, 2021

(30) Foreign Application Priority Data
May 22, 2020 (JP) 2020-089958

(51) Int. Cl. G06F 3/12; G05B 13/02

(52) U.S. Cl. CPC G06F 3/1208; G06F 3/121; G05B 13/0265; G06F 3/1259; G06F 3/1273; G06F 3/1234

(57) ABSTRACT

An image processing system includes an image processing apparatus and a server, wherein the image processing apparatus includes: an image forming part; a first hardware processor that executes machine learning related to determination of a predetermined control parameter value of the image forming part; and a communication part that transmits a learning model after the machine learning as a tentatively determined learning model to the server, the server includes a second hardware processor that determines pass or fail of a standard test with a control parameter selected by the tentatively determined learning model, and transmits a result of the pass or fail to the image processing apparatus, and the image processing apparatus further includes a third hardware processor that updates the tentatively determined learning model in accordance with a result of the pass or fail, to set as a learning model to be executed in the image processing apparatus.

The entire disclosure of Japanese patent Application No. 2020-089958, filed on May 22, 2020, is incorporated herein by reference in its entirety.

### BACKGROUND

### Technological Field

The present invention relates to an image processing system, an image processing apparatus, a program, a control management system, and a device.

### Description of the Related Art

For electrical products and electronic devices used in homes and offices, manufacturing apparatuses installed in factories, medical devices, and the like, there are regulations (standards) related to ensuring safety and environmental protection. One example is a regulation of an electromagnetic interference wave. To a developing device provided in an electrophotographic image processing apparatus such as a multifunction machine, a voltage including a high-voltage DC component and an AC component of a high-frequency rectangular wave is applied. Since the AC component is a rectangular wave, the AC component contains many high-frequency components and has a high voltage, and thus electromagnetic interference waves are likely to be generated. For this reason, before shipping, manufacturers of image processing apparatuses test and confirm that regulations for electromagnetic interference waves are cleared (a radio field intensity of an electromagnetic interference wave is equal to or less than a standard limit value).

Whereas, image processing apparatuses are required to have high image quality of images, high durability, and support for many paper types, and adjustment of a voltage and a frequency is required even after shipment. Further, adjustment is also required to cope with an environment (a temperature, a humidity, and the like) in which the image processing apparatus is installed. The high durability means that, even if the image processing apparatus changes over time, a usage period is extended by adjusting control parameters of a voltage, a frequency, and the like. Such adjustment of control parameters after shipment is required not only for image processing apparatuses but also for various apparatuses and devices including manufacturing apparatuses and medical devices.

In general, manufacturers or distributors of apparatuses and devices adjust control parameters as part of maintenance services. In addition, with the progress of machine learning technology, a technology has emerged in which apparatuses and devices adjust control parameters in accordance with states of the apparatuses and devices. For example, the invention described in JP 5969676 B1 optimizes a tool correction interval in a machine tool from the viewpoint of a working error amount and a machine operation rate, by using reinforcement learning. Further, the invention described in JP 2018-1267% A optimizes, in a robot control device, an operational parameter of a robot from the viewpoint of operation time, a deviation from a target position, vibration, and the like by using reinforcement learning.

In the inventions described in JP 5969676 B1 and JP 2018-126796 A, control parameters are optimized from the viewpoint of machine operation accuracy, operation time, efficiency, and the like. Whereas, apparatuses and devices are required to conform with national and industrial regulations and standards. For example, it is necessary to comply with regulations set by the voluntary control council for interference by information technology equipment (VCCI) related to electromagnetic interference waves, the electromagnetic compatibility (EMC) directive of EU, and the low voltage directive of EU related to safety of electrical products.

When a control parameter is changed, a value subjected to the regulation (for example, a radio field intensity of an electromagnetic interference wave emitted by a device, in the EMC directive) may change to exceed a limit value. However, in the inventions described above, there is no description regarding regulations, and regulations are not considered.

### SUMMARY

The present invention has been made in view of such a background, and an object is to provide an image processing system, an image processing apparatus, a program, a control management system, and a device for enabling a change in a control parameter calculated by machine learning within a range conforming to a standard.

To achieve the abovementioned object, according to an aspect of the present invention, an image processing system reflecting one aspect of the present invention comprises an image processing apparatus and a server, wherein the image processing apparatus comprises: an image forming part; a first hardware processor that executes machine learning related to determination of a predetermined control parameter value of the image forming part; and a communication part that transmits a learning model after the machine learning as a tentatively determined learning model to the server, the server comprises a second hardware processor that determines pass or fail of a standard test with a control parameter selected by the tentatively determined learning model, and transmits a result of the pass or fail to the image processing apparatus, and the image processing apparatus further comprises a third hardware processor that updates the tentatively determined learning model in accordance with a result of the pass or fail, to set as a learning model to be executed in the image processing apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an overall configuration diagram of an image processing system according to the present embodiment;

FIG. 2 is an internal configuration view of an image processing apparatus according to the present embodiment;

FIG. 3 is a functional block diagram of the image processing apparatus according to the present embodiment;

FIG. 4 is a view illustrating a voltage applied to a developing device of the image processing apparatus according to the present embodiment;

FIG. 5 is a view for explaining an example of a standard limit value of an electromagnetic interference wave;

FIG. 6 is a functional block diagram of a server according to the present embodiment;

FIG. 7 is a data structure view of a testing image processing apparatus database stored in the server according to the present embodiment:

FIG. 8 is a sequence diagram of a learning model updating process of the image processing system according to the present embodiment;

FIG. 9 is a flowchart of a printing process of an image processing apparatus (a user machine) according to the present embodiment;

FIG. 10 is a flowchart of a test printing process of an image processing apparatus (a test target machine) according to the present embodiment:

FIG. 11 is a functional block diagram of a server according to Modification 1 of the present embodiment;

FIG. 12 is a data structure view of a passed learning model database stored in the server according to Modification 1 of the present embodiment;

FIG. 13 is a sequence diagram of a learning model changing process of an image processing system according to Modification 1 of the present embodiment;

FIG. 14 is a data structure view of a parameter type database stored in an image processing apparatus according to Modification 2 of the present embodiment; and

FIG. 15 is a data structure view of a passed learning model database stored in a server according to Modification 3 of the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an image processing system in a form (an embodiment) for implementing the present invention will be described below. The image processing system includes an image processing apparatus (a user machine) used by a user, a server, and an image processing apparatus (a test target machine) installed in a test room. The user machine updates a control parameter by using machine learning technology. Specifically, the user machine prints a test chart, reads a print result, evaluates an image at a current control parameter, updates a machine learning model, and transmits the updated machine learning model to the server. The server sets the machine learning model on the test target machine, tests whether the control parameter determined by the machine learning model meets a regulation of electromagnetic interference waves, and notifies the user machine of pass or fail. In a case of pass, the user machine updates the machine learning model with a positive reward, and sets the control parameter determined by the updated machine learning model. In a case of fail, the user machine updates the machine learning model with a negative reward.

One of the machine learning technologies is reinforcement learning. With a set value of the control parameter as a state and a change of the set value as an action, by determining a reward on the basis of the print result of the test chart and the test result of the electromagnetic interference wave for improving image quality by reinforcement learning, the control parameter can be changed (optimized). Machine learning technologies other than reinforcement learning may be used.

By executing a test (a standard test) as to whether the control parameter meets the regulation of electromagnetic interference waves on the test target machine, it is possible to guarantee that the regulation is met even for the user machine. Further, it is possible to improve the image quality for each user machine within a range of meeting the regulation. It is possible to optimize the control parameter in consideration of variations in components of the image processing apparatus (the user machine), an environment in which the user machine is installed, and changes over time.

In the following embodiment, an electromagnetic interference wave will be described as an example (an example of safety regulation) as a regulation (a standard), but other laws and treaties, regulations, standards, references, and the like (also referred to as legal regulations) by various organizations may be adopted.

<<Overall Configuration of Image Processing System>>

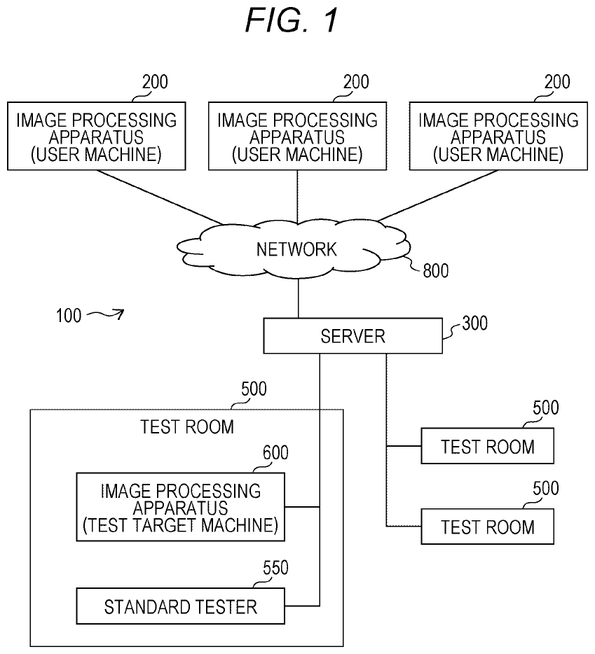

FIG. 1 is an overall configuration diagram of an image processing system 100 according to the present embodiment. The image processing system 100 includes an image processing apparatus 200 (a user machine), a server 300, and an image processing apparatus 600 (a test target machine). The image processing apparatus 200 is an image processing apparatus used by a user, and can communicate with the server 300 via a network 800.

The image processing apparatus 600 (the test target machine) is installed in a test room 500 (an anechoic chamber), and an intensity of an electromagnetic interference wave emitted by the image processing apparatus 600 is measured by a standard tester 550. A measurement result of the standard tester 550 is transmitted to the server 300. The test room 500 is equipped with an air-conditioning facility, and a temperature and a humidity in the room can be adjusted. Therefore, it is possible to conduct a standard test while changing an installation environment of the image processing apparatus 600.

In FIG. 1, one image processing apparatus 600 and one standard tester 550 are installed in one test room 500. However, without limiting to this, a plurality of image processing apparatuses 600 and a plurality of standard testers 550 may be installed. Further, a plurality of test rooms 500 are connected to one server 300, but one test room 500 may be used.

<<Configuration of Image Processing Apparatus (User Machine)>>

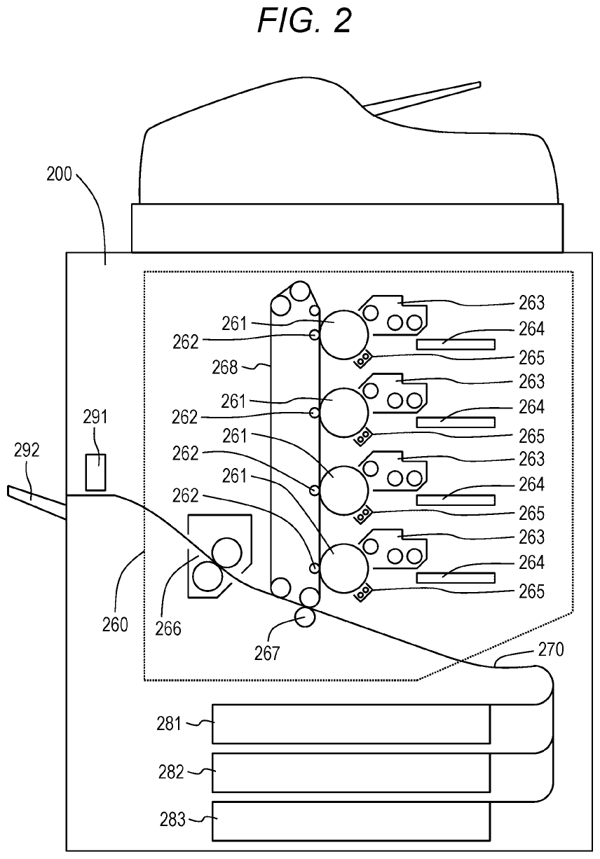

FIG. 2 is an internal configuration view of the image processing apparatus 200 according to the present embodiment. The image processing apparatus 200 includes paper feeding trays 281, 282, and 283, a conveyance path 270, an image forming part 260, a scanner 291, and a paper discharging tray 292. In the paper feeding trays 281, 282, and 283, paper (a recording medium) is set. The paper is conveyed on the conveyance path 270, printed (formed with an image) by the image forming part 260, and discharged to the paper discharging tray 292. The scanner 291 is provided on the conveyance path 270 between the image forming part 260 and the paper discharging tray 292, to read an image on printed paper.

The image forming part 260 includes a laser 264, a photoconductor 261, a developing device 263, an electrifying pole 265, a primary transfer roller 262, a primary transfer belt 268, a secondary transfer roller 267, and a fixing device 266. Four each of the laser 264, the photoconductor 261, the developing device 263, the electrifying pole 265, and the primary transfer roller 262 are provided in correspondence to four YMCK colors.

The image forming part 260 forms an image on paper conveyed along the conveyance path 270, by the electrophotographic system. Specifically, the photoconductor 261 is charged by the electrifying pole 265, a latent image is formed on the photoconductor 261 by the laser 264, and toner is applied on the photoconductor 261 by the developing device 263. The toner on the photoconductor 261 is transferred to the primary transfer belt 268 by the primary transfer roller 262, and the toner of four colors is superimposed on the primary transfer belt 268 to form a toner image. The toner image on the primary transfer belt 268 is transferred to paper on the conveyance path 270 by the secondary transfer roller 267.

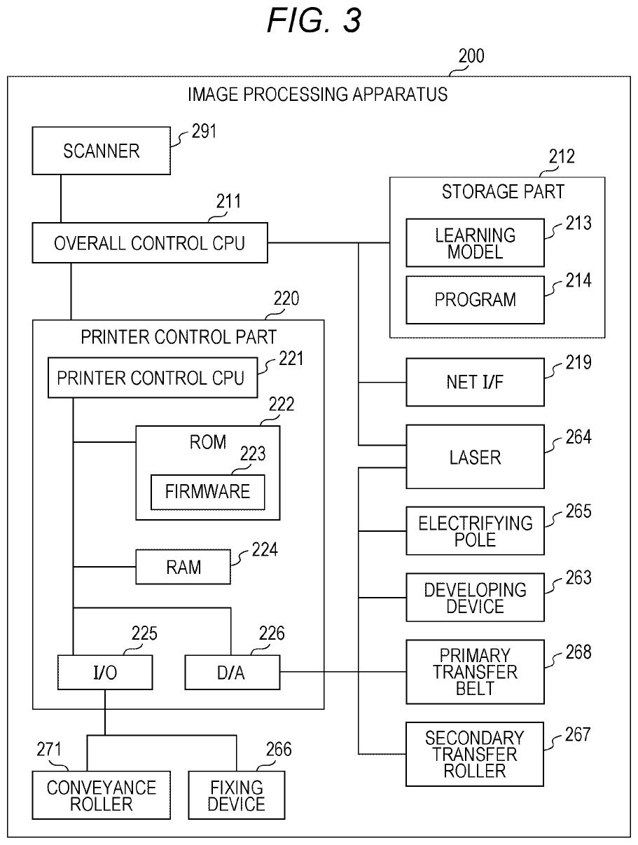

FIG. 3 is a functional block diagram of the image processing apparatus 200 according to the present embodiment. The image processing apparatus 200 includes an overall control central processing unit (CPU) 211, a storage part 212, a printer control part 220, a network interface 219 (described as “net I/F” in FIG. 3, also referred to as a communication part), the laser 264, and the scanner 291.

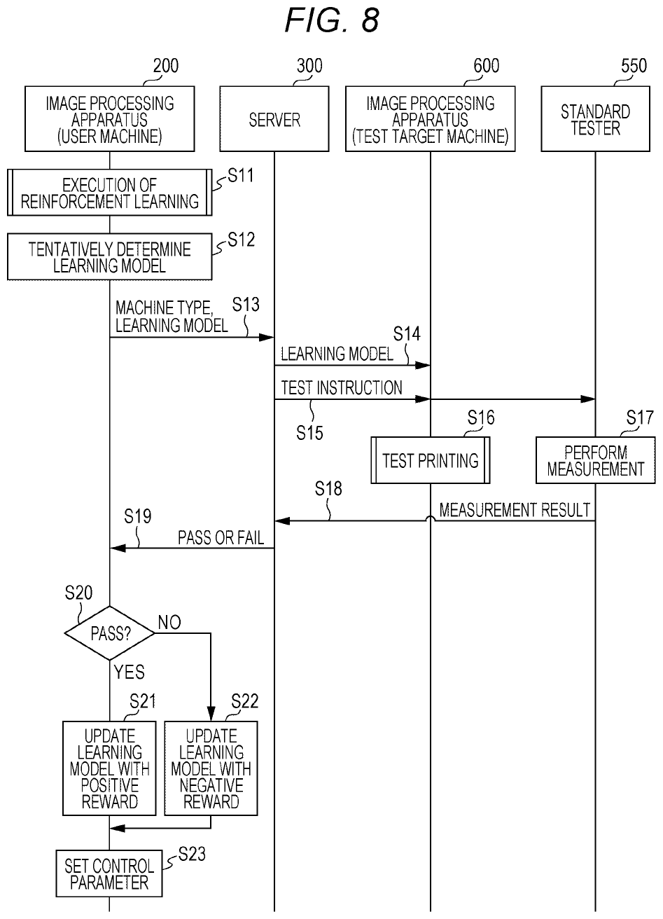

The overall control CPU 211 functions as a control part that controls the entire image processing apparatus 200 by executing a program 214 stored in the storage part 212. Further, the overall control CPU 211 controls ON/OFF of the laser 264, to forma latent image on the photoconductor 261. Another control is changing (adjusting) of a control parameter related to image quality. A control parameter changing process of the image processing system 100 including the image processing apparatus 200 will be described with reference to FIG. 8 described later.

In addition to the program 214, the storage part 212 stores a learning model 213 (a machine learning model) described later. The network interface 219 (the communication part) transmits and receives communication data to and from the server 300, which is a component of the image processing system 100. In addition, the network interface 219 transmits and receives communication data with another device such as a personal computer, and receives print job data. The scanner 291 reads an image formed on paper on the conveyance path 270, and outputs the image to the overall control CPU 211.

The printer control pan 220 includes a printer control CPU 221, a read only memory (ROM) 222, a random access memory (RAM) 224, an I/O unit 225, and a D/A unit 226. The printer control CPU 221 operates in accordance with a firmware 223 stored in the ROM 222 to control the image forming part 260 (see FIG. 2), and temporarily stores temporary data required for control into the RAM 224. The printer control CPU 221 controls a conveyance roller 271 provided on the conveyance path 270 and the fixing device 266, via the I/O unit 225. Further, the printer control CPU 221 controls the laser 264, the electrifying pole 265, the developing device 263, the primary transfer belt 268, and the secondary transfer roller 267 via the D/A unit 226.

<<Relationship Between Development Voltage and Image>>

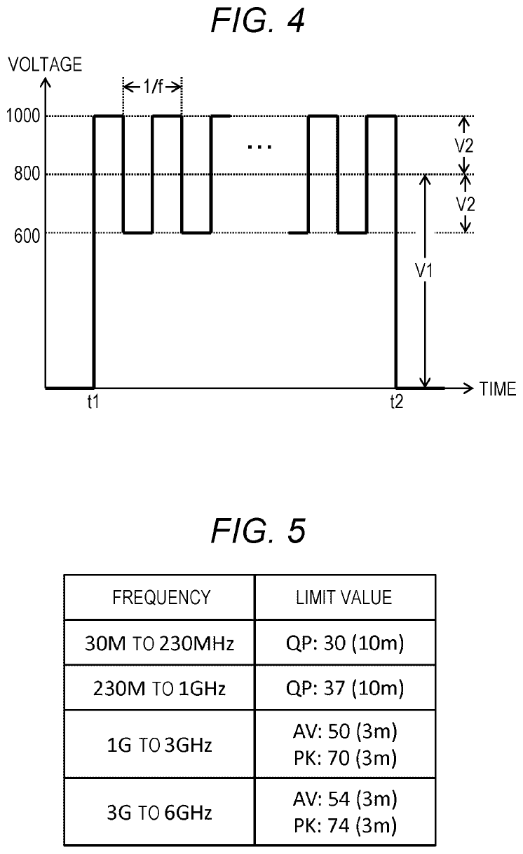

FIG. 4 is a view illustrating a voltage applied to the developing device 263 of the image processing apparatus 200 according to the present embodiment. By applying a voltage to toner of the developing device 263, the toner moves to a latent image on the photoconductor 261. The applied voltage includes a DC component and an AC component.

A voltage (a development voltage) V1 of the DC component in FIG. 4 is 800 V. The AC component is a rectangular wave, an amplitude V2 is 200 V, and a frequency f is 3 KHz. Before a time t1 and after a time t2 is an idling state, and no voltage is applied. Between the time t1 and the time t2 is a printing state, and the voltage illustrated in the figure is applied to the developing device 263.

Adjusting the voltage V1 of the DC component changes a maximum density of an image. In addition, adjusting the amplitude V2 of the AC component changes an intermediate density, and adjusting the frequency f changes image noise and unevenness. Adjusting these voltage and frequency enables the image quality to be adjusted and improved. However, since the rectangular wave contains a high-frequency component and has a high voltage, an electromagnetic interference wave is likely to be generated, and adjustment is required within a range of a regulation such as VCCI.

FIG. 5 is a view for explaining an example of a standard limit value of an electromagnetic interference wave. In FIG. 5, a peak (PK), a quasi-peak (QP), and an average (AV) respectively indicate a peak value, a quasi-peak value, and an average value of an electromagnetic interference wave, and a unit is dBμV/m. A bottom line in FIG. 5 indicates that a limit value of the electromagnetic interference wave of 3 GHz to 6 GHz at a measurement distance of 3 m is 54 dBμV/m on an average value, and 74 dBμV/m on a peak value.

<<Configuration of Image Processing Apparatus (Test Target Machine)>>

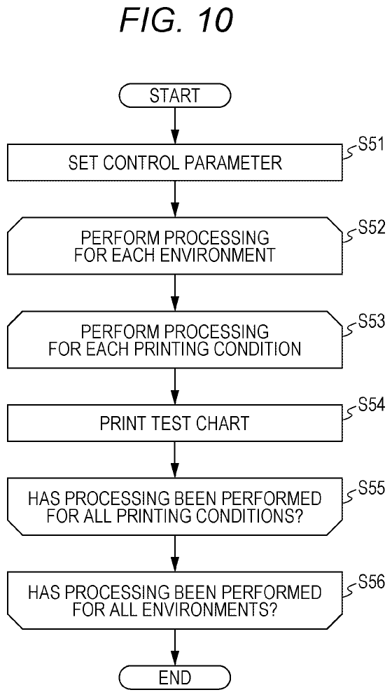

A basic configuration of the image processing apparatus 600 (the test target machine) is similar to that of the image processing apparatus 200 (the user machine) (see FIGS. 2 and 3). While the image processing apparatus 200 processes a print job instructed by a user (prints print data transmitted by the user), the image processing apparatus 600 sets a learning model transmitted by the server 300 as its own learning model 213, and prints a test chart. Specifically, the image processing apparatus 600 sets a control parameter determined by its own learning model 213, and prints the test chart while changing an environment and a printing condition (see FIG. 10 described later). The standard tester 550 measures an electromagnetic interference wave generated by the image processing apparatus 600 at the time of printing, and transmits a measurement result to the server 300.

<<Server Configuration>>

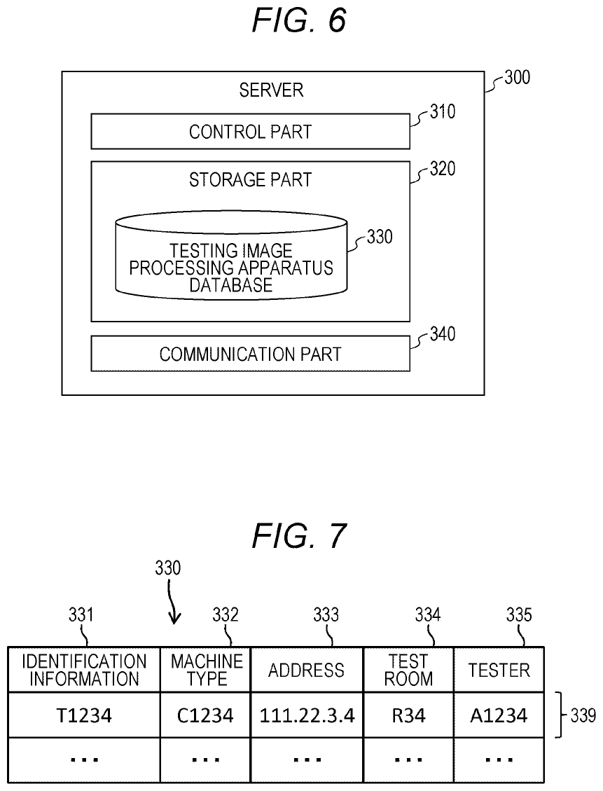

FIG. 6 is a functional block diagram of the server 300 according to the present embodiment. The server 300 is a computer, and includes a control part 310, a storage part 320, and a communication part 340. The server 300 receives the learning model 213 from the image processing apparatus 200 (the user machine), and uses the image processing apparatus 600 (the test target machine) to test whether the learning model 213 conforms with the regulation (the standard). Specifically, the control part 310 (a determination part) of the server 300 sets the learning model 213 in the image processing apparatus 600, and instructs execution of the test print. The control part 310 receives the measurement result of the intensity of the electromagnetic interference wave from the standard tester 550, determines pass or fail of the standard test, and notifies the image processing apparatus 200 of a determination result. A control parameter changing process of the image processing system 100 including the server 300 will be described with reference to FIG. 8 described later.

The communication part 340 transmits and receives communication data with the image processing apparatuses 200 and 600 and the standard tester 550. The storage part 320 stores a testing image processing apparatus database 330 (see FIG. 7 described later).

FIG. 7 is a data structure diagram of the testing image processing apparatus database 330 stored in the server 300 according to the present embodiment. The testing image processing apparatus database 330 is tabular data, and one row (record) indicates one image processing apparatus 600 (the test target machine). The record of the testing image processing apparatus database 330 includes columns (attributes) of identification information 331, a machine type 332, an address 333, a test room 334, and a tester 335.

The identification information 331, the machine type 332, and the address 333 are identification information, a machine type, and a network address of the image processing apparatus 600. The test room 334 is identification information of the test room 500 (see FIG. 1) in which the image processing apparatus 600 is installed. The tester 335 is identification information of the standard tester 550 (see FIG. 1) that measures an intensity of an electromagnetic interference wave generated by the image processing apparatus 600.

The number of a machine type (a machine type name) included in the machine type 332 is not limited to one, and a plurality of machine types may be included as long as the machine types can be regarded as equivalent in the electromagnetic interference wave test. Further, the number of pieces of the identification information of the standard tester 550 included in the tester 335 is not limited to one, and a plurality of pieces of identification information are included when the electromagnetic interference wave is measured by a plurality of the standard testers 550.

A record 339 is information of the image processing apparatus 600 whose identification information 331 is “T1234”, machine type is “C1234”, and network address is “111.22.3.4”. Further, this image processing apparatus 600 is installed in the test room 500 of “R34”, and the electromagnetic interference wave is measured by the standard tester 550 whose identification information is “A1234”.

<<Learning Model Updating Process>>

Before explaining an updating process of the learning model 213 (see FIG. 3), reinforcement learning of a control parameter executed by the overall control CPU 211 (a control part) of the image processing apparatus 200 (the user machine) will be described. The control parameters, which are a target of the reinforcement learning in the present embodiment, are control parameters for setting the voltage V1 of the DC component, the amplitude V2 of the AC component, and the frequency f (see FIG. 4), and are individually adjusted to be optimal by different reinforcement learning.

The optimum state means that a print result of the test chart is optimized. Specifically, the optimum state is that the test chart is printed, the scanner 291 reads an image of the print result, and there is no maximum density error, no halftone density error, and no image noise in the scanned image. The image processing apparatus 200 executes reinforcement learning to obtain set values (control parameter values) of the optimum voltage V1, amplitude V2, and frequency f.

A state in the reinforcement learning of the voltage V1 (also referred to as reinforcement learning A) is a set value (a control parameter value) of the voltage V1, an action is a change of the set value, and a reward is a reduction amount (an improvement amount) of a maximum density error before and after the change. A state in reinforcement learning of the amplitude V2 (also referred to as reinforcement learning B) is a set value of the amplitude V2, an action is a change of the set value, and a reward is a reduction amount of a halftone density error before and after the change. A state in reinforcement learning of the frequency f (also referred to as reinforcement learning C) is a set value of the frequency f, an action is a change of the set value, and a reward is a reduction amount in image noise before and after the change.

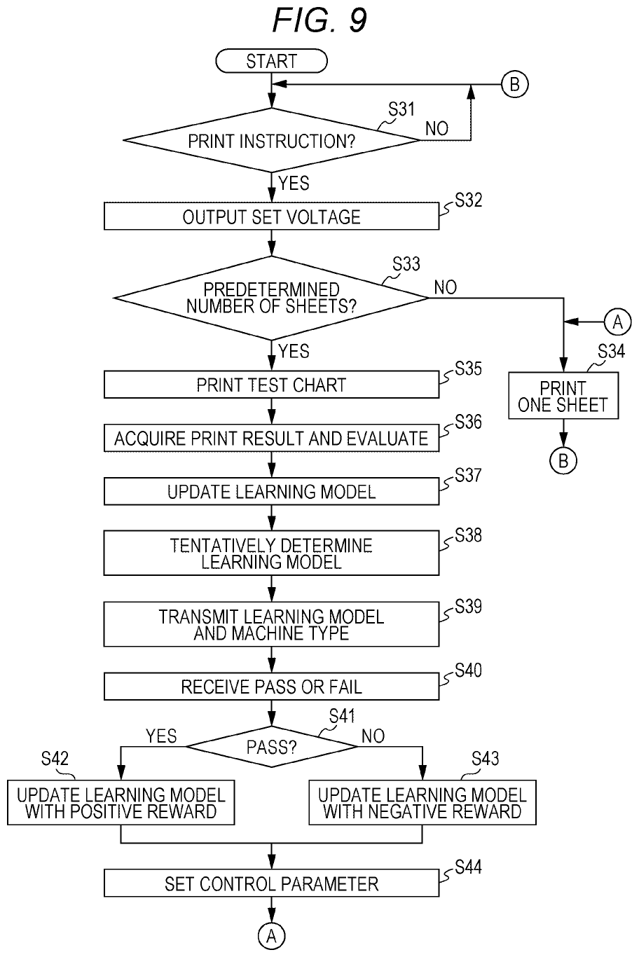

The image processing apparatus 200 (the overall control CPU 211, a machine learning execution part) executes, simultaneously in parallel, three reinforcement learning, which are the reinforcement learning A (corresponding to the voltage V1) for improving a maximum density error, the reinforcement learning B (corresponding to the amplitude V2) for improving a halftone density error, and the reinforcement learning C (corresponding to the frequency f) for improving image noise. Specifically, the image processing apparatus 200 (the overall control CPU 211) prints a test chart containing multiple test patches with multiple voltages near the currently set voltage V1 (a DC component of a development bias), multiple test patches with multiple amplitudes near the amplitude V2 (an AC component of the development bias), and multiple test patches with multiple frequencies near the frequency f (see step S35 in FIG. 9 described later), and scans a print result with the scanner 291 (see step S36).

Subsequently, the image processing apparatus 200 calculates a reward from a reduction amount in the maximum density error, a reduction amount in the halftone density error, and a reduction amount in the image noise in the scanned image, and updates the learning model 213 of the reinforcement learning A, B, and C described above (see step S37). As the reduction amount is larger, the reward becomes larger. For example, Q-learning may be adopted as the reinforcement learning, and the image processing apparatus 200 may update a value (an action value) of an action (a change of a set value) in a state (a set value) on the basis of the reward. On the basis of this reward, the learning model 213 for improving image quality is updated. The learning model 213 is data indicating this action value.

Next, the image processing apparatus 200 tentatively determines the updated learning model 213 as a learning model 213 (also referred to as a tentatively determined learning model) for selecting a change value of a control parameter (see step S44) for further improving image quality (see step S38). The image processing apparatus 200 transmits the tentatively determined learning model 213 to the server 300 (see step S39), and requests a test of an electromagnetic interference wave.

Subsequently, the image processing apparatus 200 (the overall control CPU 211, an updating part) updates the learning model 213 with a reward according to a pass/fail result of the electromagnetic interference wave test received from the server 300 (see steps S42 and S43). Next, the image processing apparatus 200 changes to the change value of the control parameter selected by the updated learning model 213 (see step S44). This change value will be evaluated at printing of the test chart next time (see step S35).

<<Learning Model Updating Process: Overall Operation of Image Processing System>>

FIG. 8 is a sequence diagram of a learning model updating process of the image processing system 100 according to the present embodiment. With reference to FIG. 8, an updating process of the learning model 213 executed by the image processing system 100 will be described. Note that the reinforcement learning executed by the image processing apparatus 200 (the user machine) will be described with reference to FIG. 9 described later.

In step S11, the image processing apparatus 200 (the overall control CPU 211 that functions as the control part or the machine learning execution part) executes reinforcement learning. At this time, the image processing apparatus 200 updates the learning model 213.

In step S12, the image processing apparatus 200 tentatively determines the learning model 213 updated in step S11 as a learning model for selecting a change value of a control parameter for further improving image quality (see step S23). Note that details of the processes in steps S11 to S12 will be described with reference to FIG. 9 described later.

In step S13, the image processing apparatus 200 transmits its own machine type and the learning model 213 to the server 300.

In step S14, the server 300 (the control part 310 (the determination part)) transmits the learning model to the image processing apparatus 600 (the test target machine), and instructs the image processing apparatus 600 to set as its own learning model. Specifically, the server 300 searches the testing image processing apparatus database 330 (see FIG. 7) for a record containing the machine type received in step S13 in the machine type 332, and specifies the image processing apparatus 600 (the test target machine) of the same machine type as the image processing apparatus 200 (the user machine). Next, the server 300 transmits the learning model to the specified image processing apparatus 600, to instruct to change the learning model of the image processing apparatus 600 to the learning model received in step S13.

In step S15, the server 300 (the control part 310 (the determination part)) instructs the image processing apparatus 600 and the standard tester 550 to perform the test. Note that the standard tester 550 is the standard tester 550 (see FIG. 1) indicated in the tester 335 (see FIG. 7) corresponding to the image processing apparatus 600 specified in step S14.

In step S16, the image processing apparatus 600 (the test target machine) executes a test printing process. Details of the test printing process will be described with reference to FIG. 10 described later.

In step S17, the standard tester 550 measures an electromagnetic interference wave during the test printing process.

In step S18, the standard tester 550 transmits a measurement result of the electromagnetic interference wave to the server 300.

In step S19, the server 300 compares the measurement result with the standard limit value of the regulation (see FIG. 5) to determine pass or fail, and transmits the pass or fail to the image processing apparatus 200.

In step S20, the image processing apparatus 200 proceeds to step S21 if the test is passed (step S20→YES), and proceeds to step S22 if the test is failed (step S20→NO).

In step S21, the image processing apparatus 200 updates the learning model 213 that has been tentatively determined in step S12, by giving a positive reward for the selection of the control parameter for improving the image quality.

In step S22, the image processing apparatus 200 updates the learning model 213 that has been tentatively determined in step S12, by giving a negative reward for the selection of the control parameter for improving the image quality.

In step S23, the image processing apparatus 200 selects and sets the change value of the control parameter for improving the image quality by using the learning model 213 updated in steps S21 and S22.

<<Learning Model Updating Process: Operation of Image Processing Apparatus>>

FIG. 9 is a flowchart of a printing process of the image processing apparatus 200 (the user machine) according to the present embodiment. With reference to FIG. 9, a description is given to the printing process executed by the image processing apparatus 200 (the overall control CPU 211 (the machine learning execution part, the updating part) shown in FIG. 3) corresponding to steps S11 to S13 and S19 to S23 in FIG. 8.

In step S31, the image processing apparatus 200 proceeds to step S32 if there is a print instruction (step S31→YES), and returns to step S31 if there is no print instruction (step S31→NO).

In step S32, the image processing apparatus 200 applies a set voltage (a development voltage) based on a set value of a current control parameter, to the developing device 263.

In step S33, the image processing apparatus 200 proceeds to step S35 if a predetermined number of sheets have been printed since a previous test chart printing (step S33→YES), and proceeds to step S34 if not printed (step S33→NO).

In step S34, the image processing apparatus 200 prints one sheet and returns to step S31.

In step S35, the image processing apparatus 200 prints a test chart.

In step S36, the image processing apparatus 200 acquires a print result of the test chart print read by the scanner 291, and calculates a maximum density error, a halftone density error, and an image noise amount.

In step S37, the image processing apparatus 200 updates the learning model 213. Specifically, from the values calculated in step S36, the image processing apparatus 200 calculates, as a reward, a reduction amount (an improvement amount) in an error and a noise amount in a previous change of control parameters (see step S44, step S23 in FIG. 8), and updates an action value (the learning model 213 in FIG. 3).

In step S38, the image processing apparatus 200 tentatively determines the learning model 213 updated in step S37 as a learning model for selecting a change value of a control parameter (see step S44) for further improving the image quality.

In step S39, the image processing apparatus 200 transmits the tentatively determined learning model 213 and its own machine type to the server 300.

Step S40 and subsequent steps are similar to step S19 and subsequent steps in FIG. 8.

FIG. 10 is a flowchart of the test printing process (see step S16 in FIG. 8) of the image processing apparatus 600 (the test target machine) according to the present embodiment. With reference to FIG. 10, details of the test printing process will be described.

In step S51, the image processing apparatus 600 sets a control parameter. Specifically, the image processing apparatus 600 selects and sets a control parameter for improving image quality, by using the learning model set in step S14 (see FIG. 8) (the action in the reinforcement learning).

In step S52, the image processing apparatus 600 starts a process of repeating steps S53 to S55 for each environment. The environment is an installation environment of the image processing apparatus 600, and is nine combinations of a temperature (a high temperature, normal, a low temperature) and a humidity (a high humidity, normal, a low humidity). The image processing apparatus 600 gives instruction to the air-conditioning facility in the test room 500 (see FIG. 1), and repeatedly executes the processes of steps S53 to S55 after a temperature and a humidity in the test room 500 reach the temperature and humidity in the combination.

In step S53, the image processing apparatus 600 starts a process of repeating step S54 for each printing condition. The printing condition is a combination of a print operation mode, a number of prints, a paper size, and a paper type, and the process of step S54 is repeatedly executed for each combination.

In step S54, the image processing apparatus 600 prints a test chart.

In step S55, the image processing apparatus 600 proceeds to step S55 when step S54 is executed for all the printing conditions. If there is a printing condition for which the step S54 has not been executed, the image processing apparatus 600 executes step S54 with such a printing condition.

In step S56, the image processing apparatus 600 ends the test printing process when steps S53 to S55 are executed for all environments. If there is an environment for which steps S53 to S55 have not been executed, the image processing apparatus 600 executes steps S53 to S55 after the environment of the test room 500 becomes such an environment.

<<Features of Learning Model Updating Process>>

In the learning model updating process, the image processing apparatus 200 evaluates a print result of a test chart, updates the learning model 213, and makes a tentative determination (see steps S35 to S38 in FIG. 9). The server 300 determines pass or fail of a standard test of the learning model (see steps S17 to S19), by measuring an electromagnetic interference wave in the test printing process (see step S16 in FIG. 8 and FIG. 10) using the control parameter selected by the tentatively determined learning model. The image processing apparatus 200 updates the learning model 213 tentatively determined with the reward according to the pass or fail (see steps S21 and S22), and uses this updated learning model 213 to select and set a control parameter for improving image quality (see step S23).

The control parameter selected by the updated learning model 213 for improving the image quality has already passed the standard test in the image processing apparatus 600. Therefore, the image processing apparatus 200 can improve the image quality (reduce a maximum density error, a halftone density error, and image noise) while observing the standard (regulation).

In the above embodiment, the process of changing the control parameters (high voltage output parameters) related to the voltage V1 of the DC component, the amplitude V2 of the AC component, and the frequency f has been described. Without limiting to these three, the control parameters of the image processing apparatus 200 also include control parameters such as a speed and an acceleration/deceleration timing of a conveyance motor provided on the conveyance path 270, and a control parameter (a fixing heater output parameter) related to a heater of the fixing device 266, and these parameters may also be the target of optimization by reinforcement learning. Without limiting to the image quality, the reward may be calculated from, for example, shortness of processing time, lowness of noise, lowness of power consumption, lowness of toner consumption, and the like.

### Modification 1: Server Holds Passed Learning Model

In the above embodiment, the server 300 tests the learning model transmitted from the image processing apparatus 200 (the user machine) by setting to the image processing apparatus 600 (the test target machine), to notify the pass or fail (see steps S14 to S19 in FIG. 8). On the other hand, the server 300 may store passed learning models in advance, and notify of pass without the test for learning models that have passed the test in the past. Specifically, the server 300 notifies of pass without the test in a case where the learning model transmitted from the image processing apparatus 200 is equivalent to the learning model that has passed the test in the past (for example, parameters (coefficients) of the learning model match).

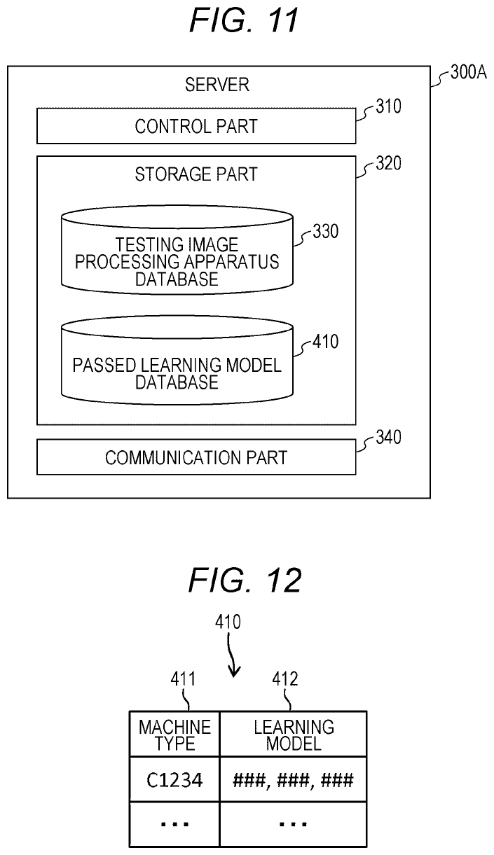

FIG. 11 is a functional block diagram of a server 300A according to Modification 1 of the present embodiment. As compared to the server 300 (see FIG. 6), the server 300A further stores a passed learning model database 410 (see FIG. 12 described later).

FIG. 12 is a data structure view of the passed learning model database 410 stored in the server 300A according to Modification 1 of the present embodiment. The passed learning model database 410 is tabular data, and stores learning models that have passed the standard test for each machine type. Columns (attributes) of the passed learning model database 410 include a machine type 411 and a learning model 412. The machine type 411 is a machine type of the image processing apparatus 200, and the learning model 412 indicates a passed learning model.

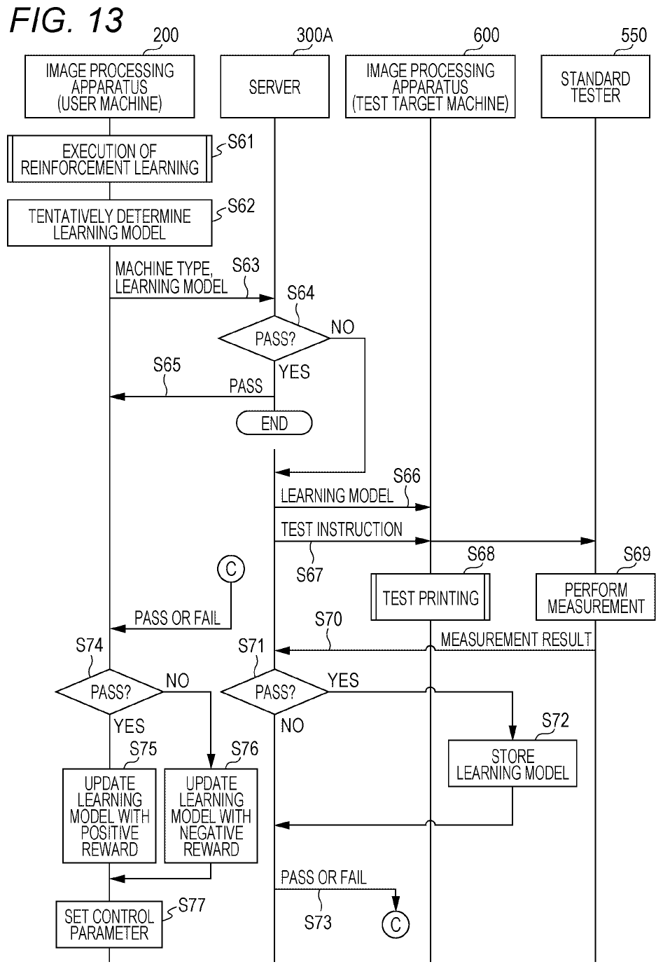

FIG. 13 is a sequence diagram of a learning model changing process of an image processing system according to Modification 1 of the present embodiment.

Steps S61 to S63 are similar to steps S11 to S13 (see FIG. 8).

In step S64, the server 300A (the control part 310 (the determination part)) determines whether or not a received learning model has passed already. Specifically, the server 300A determines whether or not the received learning model is included in the learning model 412 of a record whose machine type 411 matches the machine type received instep S63, in the passed learning model database 410 (see FIG. 12). When the learning model is included (step S64→YES), the server 300A proceeds to step S65, and when the learning model is not included (step S64→NO), the server 300A proceeds to step S66.

In step S65, the server 300A notifies of the pass. The image processing apparatus 200 that has received the pass proceeds to step S74.

Steps S66 to S70 are similar to steps S14 to S18 (see FIG. 8).

In step S71, the server 300A compares the measurement result with the standard limit value of the regulation (see FIG. 5) and determines pass or fail. Then, the server 300A proceeds to step S72 in a case of pass (step S71→YES), and proceeds to step S73 in a case of fail (step S71→NO).

In step S72, the server 300A adds the passed learning model to the passed learning model database 410. Specifically, the server 300A specifies a record, in the passed learning model database 410, in which the machine type 411 matches the machine type received in step S63. Next, the server 300A adds the learning model to the learning model 412 of the specified record.

Step S73 and subsequent steps are similar to step S19 and subsequent steps in FIG. 8.

Providing the passed learning model database 410 to the server 300A makes response of the server 300A faster. Specifically, if the learning model transmitted by the image processing apparatus 200 is a learning model that has passed in the past, the server 300A notifies of the pass without the test (see step S65). Therefore, in the printing process of the image processing apparatus 200 (see FIG. 9), a waiting time from transmitting the learning model to receiving the pass or fail in steps S39 to S40 is shortened. In addition, useless tests that have been passed in the past can be reduced, which can reduce power required for the test. Moreover, even when learning models are continuously received from multiple image processing apparatuses 200 (the user machines) of the same machine type, the server 300A can omit the test of the learning model that has passed in the past and can start early the test that has not been passed yet, which can improve performance of the entire image processing system 100.

### Modification Example 2: Parameter Type Database of Image Processing Apparatus

In Modification 1 of the present embodiment, the server 300A stores the passed learning model database 410, and notifies of the pass without performing the test on the stored learning model. Whereas, the image processing apparatus 200 (the user machine) may store control parameters that do not require the test, to reduce the standard test of the learning model related to the control parameter (see steps S63 to S73 in FIG. 13).

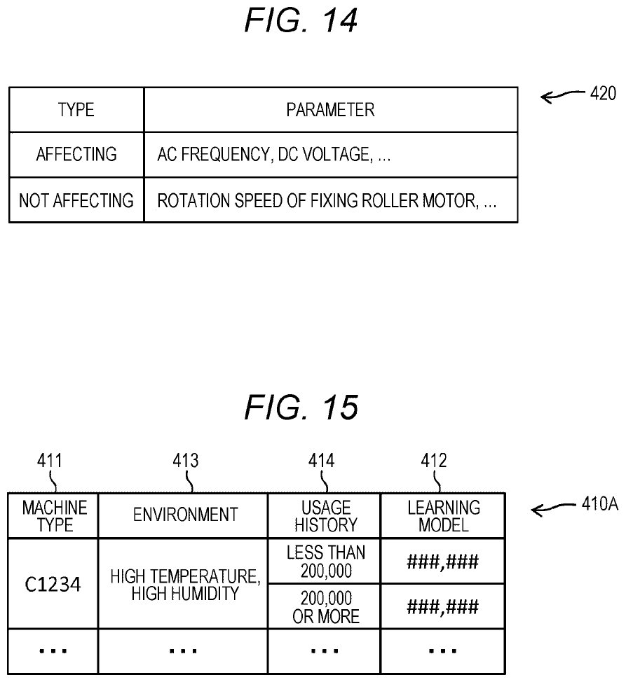

FIG. 14 is a data structure view of a parameter type database 420 stored in an image processing apparatus 200 according to Modification 2 of the present embodiment. The parameter type database 420 stores control parameters in which a change in a control parameter value affects an intensity of an electromagnetic interference wave, and control parameters in which a change does not affect an intensity of an electromagnetic interference wave. In FIG. 14, “AC frequency”, which is the frequency f of the AC component, and “DC voltage”, which is the voltage V1 of the DC component, are stored as parameters that affect an intensity of an electromagnetic interference wave. In addition, a rotation speed of a fixing roller motor provided in the fixing device 266 (see FIG. 2) is stored as a parameter that does not affect an intensity of an electromagnetic interference wave.

When the image processing apparatus 200 tentatively determines a learning model (see step S12 in FIG. 8), if the learning model is a learning model for reinforcement learning related to a parameter that affects an intensity of an electromagnetic interference wave, the image processing apparatus 200 requests the server 300 for the standard test (see step S13). Whereas, the image processing apparatus 200 does not request the server if the learning model is a learning model for reinforcement learning related to a parameter that has no effect. In this way, when there is no effect on the intensity of the electromagnetic interference wave, the updating process of the learning model of the image processing apparatus 200 can be speeded-up by not performing the standard test. In addition, a load on the server 300 can be reduced.

### Modification 3: Server Holds Passed Learning Model Associated with Installation Environment and Usage History

The passed learning model database 410 (see FIG. 12) stores learning models that have passed the standard test. The server 300A may store the passed learning models in association with an installation environment and a usage history of the image processing apparatus 200.

FIG. 15 is a data structure view of a passed learning model database 410A stored in a server 300A according to Modification 3 of the present embodiment. The passed learning model database 410A is tabular data in which attributes of an environment 413 and a usage history 414 are added to the passed learning model database 410 (see FIG. 12). The environment 413 indicates an installation environment of the image processing apparatus 200, and includes, for example, “high temperature, high humidity” and “normal, normal”. The usage history 414 indicates a cumulative number of prints.

When requesting the standard test (see step S63 in FIG. 13), the image processing apparatus 200 transmits a learning model including its own installation environment (environmental information) and a usage history (usage history information), in addition to the machine type. When the received learning model is included in the learning model 412 in which the machine type 411, the environment 413, and the usage history 414 correspond to the received machine type, installation environment, and usage history, the server 300A notifies of pass. If the received learning model is not included, the server 300A executes the test. When conducting the standard test, the standard test is conducted such that an environment of the test room 500 (see FIG. 1) matches the installation environment transmitted by the image processing apparatus 200.

The image processing apparatus 200 may exclusively transmit one of the installation environment or the usage history. Further, the passed learning model database 410A may be data in which an attribute of one of the environment 413 or the usage history 414 alone is added to the passed learning model database 410 (see FIG. 12).

### Modification 4: Reinforcement Learning for Multiple Control Parameters

In the above embodiment, the target of reinforcement learning is the voltage V1 of the DC component, the amplitude V2 of the AC component, and the frequency f (see FIG. 4), and reinforcement learning is executed for each control parameter. This is because the voltage V1 of the DC component, the amplitude V2 of the AC component, and the frequency f are independent, and changing one control parameter has no effect on another. For example, changing the voltage V1 does not affect the halftone density.

If there is a mutual influence between a plurality of control parameters in other control parameters, reinforcement learning may be executed with these control parameters as a set. In this case, the state is a set of control parameter values, and the action is a change in the plurality of control parameter values.

### Modification 5: Environment During Standard Test

When conducting the standard test, the image processing apparatus 600 performs test printing while changing the environment and the printing condition (see step S52 in FIG. 10). Specifically, the image processing apparatus 600 prints a test chart with all printing conditions in each of all environments (combinations of temperature and humidity).

Instead, the standard test may be conducted by limiting the printing of the test chart with all printing conditions to an environment of a combination of a normal temperature and a normal humidity, and printing the test chart with a typical printing condition alone in other combinations of environments. This can shorten the time for the standard test.

### Other Modifications

In the above embodiment, the image processing apparatus 200 prints a test chart and executes reinforcement learning every time a predetermined number of sheets are outputted (see steps S33→YES, S35 to S37 in FIG. 9). The image processing apparatus 200 may execute reinforcement learning at another timing. For example, the image processing apparatus 200 may execute the control parameter changing process during idling time when there is no print job to be executed.

The above embodiment is an example of the image processing system 100 including the image processing apparatus 200. Without limiting to the image processing apparatus 200, even devices such as manufacturing apparatuses, medical devices, and home appliances having control parameters can similarly optimize control parameters of the devices within a range of a regulation. Specifically, in a control management system including a device and a server, a learning model of reinforcement learning for selecting a change value of a control parameter of the device is transmitted to the server. The server sets the learning model in a device of the same type as the device, sets a control parameter determined by using the learning model, executes a standard test, and notifies the device of pass or fail. The device updates the learning model with a reward according to the pass or fail, selects control parameters using the updated learning model, and changes settings.

Although embodiments of the present invention have been described and illustrated in detail, the disclosed embodiments are made for purposes of illustration and example only and not limitation. The scope of the present invention should be interpreted by terms of the appended claims. The present invention can take various other embodiments, and various modifications such as omission and substitution can be made without departing from the gist of the present invention. The embodiment and modifications thereof are included in the scope and gist of the invention described in the present specification and the like, and are also included in the scope of the invention described in the claims and the equivalent scope thereof.

What is claimed is:

1. An image processing system comprising an image processing apparatus and a server, wherein the image processing apparatus comprises:
an image forming part;
a first hardware processor that executes machine learning related to determination of a predetermined control parameter value of the image forming part; and
a communication part that transmits a learning model after the machine learning as a tentatively determined learning model to the server,
the server comprises
a second hardware processor that determines pass or fail of a standard test with a control parameter selected by the tentatively determined learning model, and transmits a result of the pass or fail to the image processing apparatus, and
the image processing apparatus further comprises
a third hardware processor that updates the tentatively determined learning model in accordance with a result of the pass or fail, to set as a learning model to be executed in the image processing apparatus.

2. The image processing system according to claim 1, wherein
the server is connected with an image processing apparatus of same type as the image processing apparatus, and
the second hardware processor changes a learning model of the image processing apparatus of same type to the tentatively determined learning model, and determines pass or fail of the standard test by using the image processing apparatus of same type.

3. The image processing system according to claim 2, wherein
pass or fail determination of the standard test by using the image processing apparatus of same type is determination by conducting the standard test under a different condition.

4. The image processing system according to claim 3, wherein
the different condition includes at least one of a print operation mode, a number of prints, a paper size, a paper type, or an installation environment.

5. The image processing system according to claim 1, wherein
a storage part of the server stores a learning model that has passed the standard test, and
when the tentatively determined learning model is included in the learning model that has passed, the second hardware processor determines that the standard test has been passed.

6. The image processing system according to claim 1, wherein
the learning model includes a learning model related to a control parameter that affects a result of pass or fail of the standard test, and a learning model related to a control parameter that does not affect the standard test, and
the third hardware processor
updates the tentatively determined learning model, for a learning model related to a control parameter that affects a result of pass or fail of the standard test, in accordance with a result of the pass or fail, to set as a learning model to be executed by the image processing apparatus, and
sets a learning model related to a control parameter that does not affect a result of pass or fail of the standard test, as a learning model to be executed by the image processing apparatus, regardless a result of the pass or fail.

7. The image processing system according to claim 1, wherein
a communication part of the image processing apparatus transmits either one or both of environmental information and usage history information to the server, together with the tentatively determined learning model,
a storage part of the server stores a learning model when the standard test is passed, in association with the environmental information and the usage history information, and
when the tentatively determined learning model corresponds to a learning model when the standard test is passed, the learning model being associated with either one or both of environmental information and usage history information transmitted by the image processing apparatus, the second hardware processor determines that the standard test is passed.

8. The image processing system according to claim 1, wherein
the learning model is constructed with a coefficient of the learning model.

9. The image processing system according to claim 1, wherein
a standard of the standard test is a standard corresponding to at least one of a legal regulation or a safety regulation.

10. The image processing system according to claim 1, wherein
a control parameter determined by the machine learning is
a high-voltage output parameter and a fixing heater output parameter that are used in image formation.

11. The image processing system according to claim 1, wherein
the machine learning is reinforcement learning accompanied by a predetermined reward determination.

12. An image processing apparatus of an image processing system comprising the image processing apparatus and a server, the image processing apparatus comprising:
an image forming part;
a first hardware processor that executes machine learning related to determination of a predetermined control parameter value of the image forming part;
a communication part that transmits a learning model after the machine learning as a tentatively determined learning model to the server; and
a third hardware processor that sets a learning model to be executed by the image processing apparatus, by updating the tentatively determined learning model in accordance with a result of pass or fail of a standard test with a control parameter selected by the tentatively determined learning model, the pass or fail being determined by the server and transmitted to the image processing apparatus.

13. A non-transitory recording medium storing a computer readable program causing an image processing apparatus that is a computer, to execute:
forming an image;
executing machine learning related to determination of a control parameter value related to formation of the image;
transmitting a learning model after the machine learning as a tentatively determined learning model to a server; and
setting a learning model to be executed by the image processing apparatus, by updating the tentatively determined learning model in accordance with a result of pass or fail of a standard test with a control parameter selected by the tentatively determined learning model, the pass or fail being determined by the server and transmitted to the image processing apparatus.

14. A control management system for managing a change in a control parameter of a device having the control parameter, the control management system comprising:
a first hardware processor that executes machine learning related to determination of a value of the control parameter;
a second hardware processor that determines pass or fail of a standard test with a control parameter selected by a tentatively determined learning model that is a learning model after the machine learning; and
a third hardware processor that updates the tentatively determined learning model in accordance with a result of the pass or fail, to set as a learning model to be executed by the device.

15. A device comprising:
a first hardware processor that executes machine learning related to determination of a control parameter value;
a communication part that transmits a learning model after the machine learning as a tentatively determined learning model to a server; and
a third hardware processor that sets a learning model to be executed, by updating the tentatively determined learning model in accordance with a result of pass or fail of a standard test with a control parameter selected by the tentatively determined learning model, the pass or fail being determined and returned by the server.
